(19) United States
(12) Patent Application Publication
(10) Pub. No.: US 2013/0263948 A1
(43) Pub. Date: Oct. 10, 2013

(54) DEVICE FOR CONTROLLING A HYDRAULIC ACCUMULATOR OF A HYDRAULIC SYSTEM

(71) Applicants: Ruediger Block, Korntal-Muenchingen (DE); Nils Steinbach, Bietigheim-Bissingen (DE); Wolfgang Rudolph, Pommersfelden (DE); Werner Hess, Stuttgart (DE); Ianislav Krastev, Ludwigsburg (DE); Manfred Stachely, Pyrbaum (DE); Helmut Schneider, Aichtal (DE); Steffen Strauss, Ruthheim (DE); Uwe Kulow, Ludwigsburg (DE); Christof Ott, Asperg (DE)

(72) Inventors: Ruediger Block, Korntal-Muenchingen (DE); Nils Steinbach, Bietigheim-Bissingen (DE); Wolfgang Rudolph, Pommersfelden (DE); Werner Hess, Stuttgart (DE); Ianislav Krastev, Ludwigsburg (DE); Manfred Stachely, Pyrbaum (DE); Helmut Schneider, Aichtal (DE); Steffen Strauss, Ruthheim (DE); Uwe Kulow, Ludwigsburg (DE); Christof Ott, Asperg (DE)

(21) Appl. No.: 13/878,308

(22) PCT Filed: Sep. 8, 2011
(86) PCT No.: PCT/EP2011/065543

§ 371 Date: Jun. 18, 2013

(30) Foreign Application Priority Data
Oct. 8, 2010 (DE) 102010042194.4

(51) Int. Cl. F15B 1/027

(52) U.S. Cl. CPC F15B 1/027
USPC 137/624.27

(57) ABSTRACT

A device is described for controlling a hydraulic accumulator of a hydraulic system, for example a vehicle transmission, having a valve device which may connect and disconnect an accumulator-side port of the device to and from a system-side port, the valve device including at least one valve main stage, which is situated hydraulically between the accumulator-side port and the system-side port and to which a pressure prevailing hydraulically at the accumulator-side port is preferably applied by an application means in the opening direction, the valve device also including an electrically actuated control valve which may connect the system-side port to a control port of the valve main stage which acts in the closing direction of the valve main stage and to the accumulator-side port, at least one first throttle being situated between the control valve and the accumulator-side port.

### CROSS REFERENCE TO RELATED APPLICATIONS

The present application is the national stage entry of International Patent Application No. PCT/EP2011/065543, filed on Sep. 8, 2011, which claims priority to Application No. DE 10 2010 042 194.4, filed in the Federal Republic of Germany on Oct. 8, 2010.

### FIELD OF INVENTION

The present invention relates to a device for controlling a hydraulic accumulator of a hydraulic system.

### BACKGROUND INFORMATION

So-called start-stop functions for motor vehicles are known from the market, with the aid of which the internal combustion engine may be automatically turned off by a control unit when the vehicle is at a standstill. This may help save fuel in a range from approximately 3% to approximately 5%.

Automatic transmissions, for example a stepped transmission, a dual-clutch transmission or continuously variable transmission, are generally activated hydraulically and require a hydraulic pressure and a hydraulic volumetric flow for operation. The latter is provided by a mechanical pump (i.e., one driven by the internal combustion engine), the pump generally having an overdimensioned design due to the linear dependency of the volumetric flow on the rotational speed and due to reserves provided for taking into account the idling speed of the internal combustion engine and a possibly high oil temperature.

A system pressure controller sets a constant hydraulic pressure in the automatic transmission, and an excess amount of fluid is fed back into a tank or accumulator. Approaches are known in which the pump has a mechanically variable design (e.g., using an adjustment of the eccentricity of a vane pump), which may result in fuel savings.

When the internal combustion machine is stopped during the stopping phase, and when the hydraulic pump is stopped, the transmission may no longer be supplied with sufficient pressure or sufficient volumetric flow. Since the hydraulic circuit has certain leaks, the clutches and brakes are placed in an unpressurized (i.e., generally opened) position with the aid of restoring springs.

When the internal combustion engine restarts, it takes a certain amount of time before the mechanical pump generates enough pressure again. This results in a corresponding time delay before a starting torque is transmittable via the clutches. In addition, undesirable torque jumps may result when the clutches engage uncontrolled or slip. Furthermore, these clutches are generally not designed for the loads which occur.

To correct this, an electrically activated, on-demand oil pump may be used, which appropriately supplements the oil or hydraulic fluid in the transmission either continuously or shortly before the internal combustion engine starts. An alternative approach is to use an accumulator component. This component has the function of supplying an absent quantity of oil to the transmission shortly before and/or during the startup of the internal combustion engine, for the purpose of filling the lines and the transmission or the clutches.

An approach is furthermore known in which a spring piston accumulator—for example, one having a capacity of approximately 100 ml (milliliters)—is mechanically latched in the filled state during the stopping phase and is charged by the hydraulic pump during normal vehicle operation. The charging point in time may not be influenced, since fluid flows from the transmission hydraulic circuit to the accumulator via a filling throttle as a function of the pump pressure as early as shortly after the engine starts up (i.e., at low rotational speeds).

During the stopping phase of the internal combustion engine, a solenoid of a valve controlling the fluid exchange is energized. Before and during the restart of the internal combustion engine, when the rotational speed rises continuously, the detent is released by de-energizing the solenoid, whereby a hydraulic pressure and an adequate quantity of fluid are provided for the transmission. The emptied cavities of the hydraulic circuit are filled, so that the pressure buildup by the mechanical pump takes place rapidly, and the motor vehicle may start up without a noticeable delay.

One general approach is to combine, e.g., any type of hydraulic accumulator (for example, a gas piston accumulator, a spring piston accumulator, a gas diaphragm accumulator having a barrier layer) in connection with an electrohydraulic valve (such as a 2/2-way valve). The accumulator is charged with fluid by the transmission oil pump during normal vehicle operation. During the stopping phase, the accumulator continues to store the fluid and may discharge it to the transmission or the hydraulic system shortly before and/or during the starting phase.

The valve must meet strict requirements with regard to tightness, fluid (medium) contamination and the required flow rate. For example, it may be required to achieve a flow rate of 30 liters per minute for a period of 200 ms (milliseconds). When charging the accumulator, it must also be kept in mind that the volumetric flow is limited, for example to approximately 3 liters per minute, so that the pressure in the transmission system does not drop due to the “absent” volumetric flow, or the mechanical transmission oil pump would possibly have to be more generously dimensioned.

The following documents are known from this field, for example: German Application No. DE 10 2006 041 899 A1, German Application No. DE 10 2006 014 756 A1, German Application No. DE 10 2006 014 758 A1, Japanese Application No. JP 10-250402 A, U.S. Pat. No. 5,293,789 A1, European Application No. EP 1 265 009 B1, U.S. Patent Application Publication No. 2005/0096171 A1, European Application No. EP 1 353 075 A2 and Japanese Application No. JP 2007-138993 A.

### SUMMARY

An object of the present invention is achieved by a device and advantageous refinements described herein. Features which are important for the present invention are furthermore provided in the following description and in the drawings; the features may be important for the present invention both alone and in different combinations without explicit reference being made again thereto.

The present invention has an advantage that a hydraulic accumulator of a hydraulic system, in particular in automatic transmissions, may be filled and emptied in a controlled manner for carrying out a start-stop function of an internal combustion engine, the installation space occupied, the wear and the susceptibility to contamination being minimal and an electrical energy consumption also being minimal. In particular, the device may be designed in such a way that no electrical energy is required for holding the hydraulic accumulator pressure during a stopping phase of the internal combustion engine. The device according to the present invention operates reliably and cost-effectively and may also be manufactured comparatively easily.

The present invention is based on the consideration that a hydraulic accumulator of a hydraulic system, such as for industrial hydraulic applications or in automotive engineering—for example, for the engine oil circuit or the vehicle transmission—is to be filled and emptied in a controlled manner. This may also be referred to as a direction-dependent “volumetric flow control.” For this purpose, according to the present invention, a valve device is used which has an electromagnetically actuatable control valve and a valve main stage which is activatable thereby (for example, in the form of a switching valve). A pressure or volumetric flow source which is present in the hydraulic system (for example a mechanically driven pump) handles the filling of the accumulator.

The device includes an accumulator-side port and a system-side port. The valve main stage is situated hydraulically between the accumulator-side port and the system-side port, and a pressure prevailing at the accumulator-side port is preferably applied thereto in the opening direction. It is characteristic that the hydraulic cross section of the control valve may advantageously be much smaller in comparison to the large cross section of the valve main stage. The control valve may connect the system-side port to a control port of the valve main stage, which acts in the closing direction of the valve main stage, and also to the accumulator-side port. At least one first throttle is situated between the control valve and the control port of the valve main stage, on the one hand, and the accumulator-side port, on the other hand, this throttle ensuring a certain hydraulic separation between the control-side port and the accumulator-side port when the control valve is opened and thus a secure opening of the valve main stage, the throttle also permitting the accumulator to be gradually filled when the control valve is open while allowing the pressure prevailing at the accumulator-side port to pass to the control port of the valve main stage, thereby ensuring a secure closing of the valve main stage. This configuration provides a basic form of a hydraulically pilot-controlled valve device, which is also known as a “servo valve.” A comparatively large hydraulic volumetric flow is thereby controllable with the aid of a comparatively small control valve, making it possible to advantageously utilize the pressure prevailing in the hydraulic accumulator. The first throttle may also be designed as a diaphragm or as another type of hydraulic element which is suitable for throttling a hydraulic flow. A throttle has the advantage over a diaphragm that the volumetric flow may be limited comparatively independently of the temperature of the fluid.

The device may have at least three operating states which depend on the direction of the pressure difference and the electrical activating signal of the control valve. A first operating state makes it possible to convey fluid from the system-side port to the accumulator-side port, i.e., a hydraulic accumulator connected to the accumulator-side port may be filled or “charged” with fluid. One prerequisite for this is that the hydraulic pressure must be higher at the system-side port than at the accumulator-side port during this state. In this case, in most exemplary embodiments, the valve main stage is closed and the control valve is open. The hydraulic cross section of the control valve and additional hydraulic elements in the hydraulic path from the system-side port to the accumulator-side port limits the charge volumetric flow, which is generally desirable.

A second operating state relates to the “holding” of the hydraulic pressure at the accumulator-side port or in the hydraulic accumulator (after being filled). The hydraulic pressure is preferably approximately the same or higher at the accumulator-side port than at the system-side port. This permits an at least temporary storage of fluid. It is important that the hydraulic pressure at the control port of the valve main stage is approximately the same as the hydraulic pressure at the accumulator-side port when the control valve is blocked. This is achieved by the action of the first throttle. Hydraulic pressures which are approximately the same thus result on both sides of a valve body situated in the valve main stage. In this state, a spring, which is described below and which acts in the closing direction of the valve main stage, induces a defined blocking of the valve main stage. The control valve is preferably designed in such a way that, for example, an electromagnet is de-energized while the hydraulic pressure is being maintained and thus consumes no energy.

In a third operating state, the hydraulic pressure is higher at the accumulator-side port than at the system-side port. When the valve main stage is open, fluid may thus flow from the accumulator-side port or the hydraulic accumulator back to the system-side port. The hydraulic accumulator is thereby at least partially emptied. This operating state occurs, for example, during a restart of the internal combustion engine after it has been stopped.

According to the present invention, the emptying of the hydraulic accumulator may be carried out in a controlled manner by actuating the control valve, the control valve being temporarily opened, and a pressure changing—preferably being reduced—in a control area or at the control port of the valve main stage. As a result, the valve main stage may subsequently open, whereby the accumulator-side port and the system-side port are hydraulically connected to a comparatively large through-flow cross section.

In some exemplary embodiments of the device, the conveyance of fluid from the system-side port to the accumulator-side port, i.e., the filling of the hydraulic accumulator, may likewise be controlled by actuating the control valve. The valve main stage remains blocked, its large hydraulic cross section therefore closed, so that the fluid flow flowing through the control valve into the hydraulic accumulator is limitable, and thus no impermissible pressure drop occurs in the hydraulic system.

One exemplary embodiment of the device provides that the valve main stage includes a spring which acts in the closing direction. As a result, a valve body which is movable in the valve main stage and/or a movable piston may be placed in a defined position at any time, even when the hydraulic pressure is low or absent. By suitably dimensioning the spring properties, the operating behavior of the valve main stage may furthermore be adapted to particular requirements and hydraulic pressures.

Another exemplary embodiment of the device provides that the device includes a check valve which is situated in parallel to the first throttle and which is blocking in the direction of the control valve. Based on the basic form of the device described above, the check valve may open in the first operating state during filling of the hydraulic accumulator, so that, in addition to the first throttle, fluid may flow into the hydraulic accumulator under comparatively little resistance. The filling may thus take place faster. The through-flow cross section of the throttle may thus be given smaller dimensions. This has an advantageous effect in the third operating state during activation of the valve main stage, in that the fluid pressure at the control port of the valve main stage may drop comparatively quickly and greatly. A desired valve lift and/or a switching behavior of the valve main stage may thereby be increased or improved. The control valve may also have a smaller dimension.

Another exemplary embodiment of the present invention—which is again based on the described basic form of the device—provides that the device includes a second throttle and a check valve which are situated in series with each other and, as a whole, in parallel to the valve main stage, the check valve blocking in the direction of the system-side port. Accordingly, the check valve may open when the hydraulic pressure at the system-side port is higher than the hydraulic pressure at the accumulator-side port. In this way—if there is a corresponding pressure difference—the hydraulic accumulator may be continuously filled via the second throttle, the force of the fluid flow being essentially determined by the through-flow cross section of the second throttle. In the second and third operating states of the device, the check valve is blocking in the direction of the system-side port, and the emptying of the hydraulic accumulator may take place in a controlled manner via the valve main stage, as described above. One advantage of this exemplary embodiment is that no activation is necessary to fill the hydraulic accumulator, and no electrical energy is consumed.

Another exemplary embodiment of the device provides that the device includes a second throttle and a check valve which are situated in parallel to each other and, as a whole, between the control valve and the valve main stage, on the one hand, and the system-side port, on the other hand. The check valve is situated in such a way that it is blocking in the direction of the accumulator-side port. The filling of the hydraulic accumulator takes place in a similar way to the basic form of the device described above, with the difference that the fluid flow is additionally throttled via the second throttle. When emptying the hydraulic accumulator, the check valve opens, and the fluid flow may flow essentially unhindered to the rest of the hydraulic system via the system-side port.

Another exemplary embodiment of the device provides that a filter is situated between the control valve and the system-side port. This makes it possible to filter any dirt particles which may be present in the fluid before they are able to reach the control valve. The reliability and service life of the device according to the present invention may be further increased thereby. Furthermore, the function of the device is particularly minimally impaired by this arrangement of the filter. For example, the filter may be designed as a so-called “annular filter” and may be situated in a space-saving manner in the area of the control valve.

It is furthermore provided that an opening cross section of the control valve is larger than a through-flow cross section of the first throttle. This achieves the fact that the activation of the valve main stage by the opened control valve for emptying the hydraulic accumulator may be carried out in a defined way. For example, the valve main stage may open when a force acting upon the valve body of the valve main stage due to the hydraulic pressure at the control port, plus the force of the spring, is smaller than a force induced in the opposite direction by the hydraulic pressure at the accumulator-side port. The pressure at the control port is dependent on the ratio of the amount of fluid flowing out via the opened control valve in the direction of the system-side port and the amount of fluid flowing in from the accumulator-side port via the first throttle.

The device has a simpler configuration if the first throttle is a channel in the valve body of the valve main stage, the channel remaining open when the valve body rests on a sealing seat. The channel is preferably an axial bore in the valve body or in the piston forming the valve body. This makes it possible to save installation space and lower costs.

One exemplary embodiment of the present invention provides that the valve main stage has a valve body which includes a conical sealing section. This makes it possible to reduce the pressing of a surface onto the sealing section and thus increase the fatigue strength of the valve main stage.

Alternatively, it is provided that the valve main stage has a valve body which includes a spherical sealing section. This makes it possible to advantageously improve the tightness of the valve main stage in the closed position. The associated valve seat preferably has a conical design, so that the entire valve main stage is designed according to a ball-and-cone principle. This makes it possible to improve the sealing action of the valve main stage, and leaks may be reduced.

The valve main stage has a simpler structure if the valve body is designed to form a single piece with a guiding section, which is used to guide the valve body in a valve housing. This makes it possible to reduce the number of individual elements of the valve main stage and lower costs.

Alternatively, it is provided that the valve body and a guiding section, which is used to guide the valve body in a valve housing, are separate parts. As a result, the functions of “guiding” and “sealing” are advantageously distributed to different parts of the valve main stage. They may thus be separately optimized, so that the function of the valve main stage may be improved.

In addition, it is provided that a spring is braced between the guiding section and the valve body. The moving elements of the valve main body may thereby be placed in a defined position at any time. A tolerance compensation between the guiding section and the valve body may also take place even in the radial direction with the aid of the spring, without requiring additional elements for this purpose. The spring is preferably a pressure spring.

The valve main stage may be further improved if a damping spring or an element having corresponding damping material properties (damping member) is situated between the guiding section and the valve body. An axial damping action may thus be easily provided, whereby the function of the valve main stage may be improved, the operating noise may be reduced and the fatigue strength may be increased.

One exemplary embodiment of the present invention provides that the valve main stage is designed as a pressure-compensated slide valve. This makes it possible to essentially avoid hydraulic forces acting upon the piston or on the valve body in the axial direction and to thereby improve the function of the valve main stage.

Another exemplary embodiment of the present invention provides that a stop element is situated between the guiding section and the valve body. A defined minimum distance between the guiding section and the valve body may thus be set.

Yet another exemplary embodiment of the present invention provides that an axially acting damping element is situated between the guiding section and the valve body, which is also able to delimit an axial distance between the guiding section and the valve body. As a result, a minimum distance may, at the same time, be advantageously set between the guiding section and the valve body, and a hard stop of the valve body on the guiding section may also be avoided.

Yet another exemplary embodiment of the present invention provides that an opening cross section of the control valve is smaller than an opening cross section of the valve main body. As a result, a fluid flow set during controlled filling of the hydraulic accumulator—via the control valve—may be smaller than a fluid flow during emptying of the hydraulic accumulator.

Yet another exemplary embodiment of the present invention provides that a material of a friction bearing, in which the guiding section may slide, has approximately the same coefficient of thermal expansion as a material of the guiding section. This makes it possible to connect the valve main stage particularly precisely, and any leakage losses that may be present are also minimized.

Exemplary embodiments of the present invention are explained below with reference to the accompanying drawings.

### BRIEF DESCRIPTION OF THE DRAWINGS

FIG. 1 shows a hydraulic system of an automatic transmission which has a hydraulic accumulator.

FIG. 2 shows a first exemplary embodiment of a device for controlling the hydraulic accumulator.

FIG. 3A shows a second exemplary embodiment of the device.

FIG. 3B shows another exemplary embodiment based on FIG. 3A.

FIG. 4 shows a third exemplary embodiment of the device.

FIG. 5 shows a fourth exemplary embodiment of the device.

FIG. 6 shows a first schematic view of the device in a sectional representation.

FIG. 7 shows a second schematic view of the device in a sectional representation.

FIG. 8 shows a simplified schematic view of a valve main stage in a sectional representation.

FIG. 9 shows one exemplary embodiment of the device and the hydraulic accumulator in a sectional representation.

FIG. 10 shows a first schematic view of a piston and a valve ball.

FIG. 11 shows a second schematic view of a piston and a valve ball.

FIG. 12 shows a third schematic view of a piston and a valve ball.

FIG. 13 shows a fourth schematic view of a piston and a valve ball.

FIG. 14 shows a functional schematic view of the piston and the valve ball in a first state.

FIG. 15 shows the functional schematic view of FIG. 14 in a second state.

FIG. 16 shows the functional schematic view of FIG. 14 in a third state.

FIG. 17 shows one exemplary embodiment of the device in a sectional representation as an alternative to FIG. 9.

FIG. 18 shows a first timing diagram for operating the device.

FIG. 19 shows a second timing diagram for operating the device.

FIG. 20 shows a third timing diagram for operating the device.

FIG. 21 shows a schematic view of a combined system of a check valve and a throttle in a sectional representation.

### DETAILED DESCRIPTION

The same reference numerals are used for functionally equivalent elements and variables in all figures, even in different exemplary embodiments. In many of the modified exemplary embodiments explained, only the essential differences from the preceding exemplary embodiment or the preceding exemplary embodiments are discussed in the description of the function.

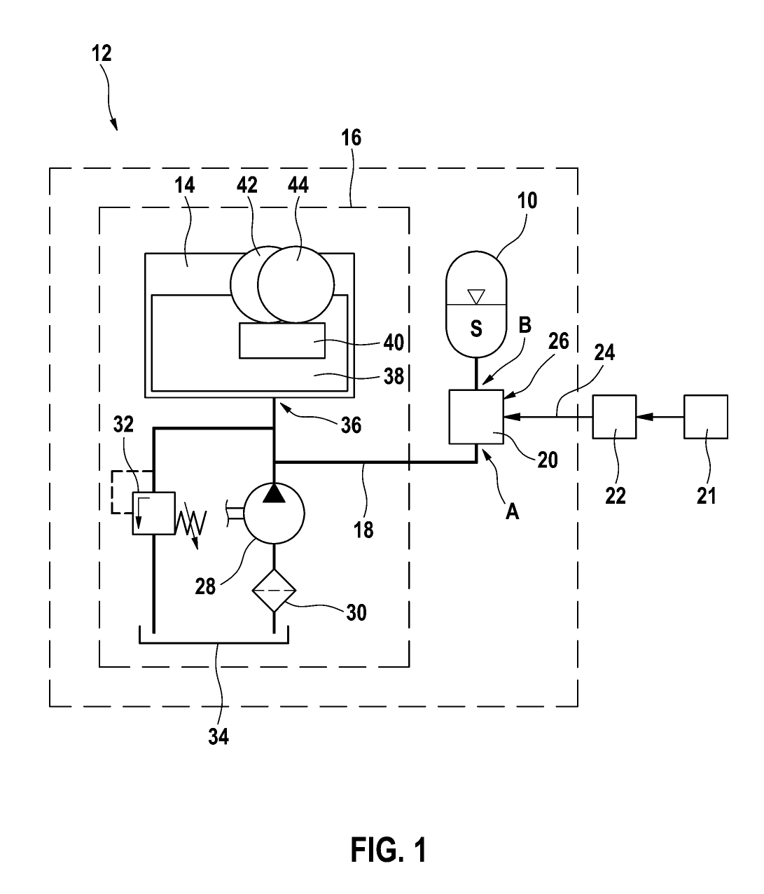

FIG. 1 shows a simplified schematic representation of a configuration of a hydraulic accumulator 10 in a hydraulic system 12 of an automatic transmission 14 of a motor vehicle, which is not illustrated in further detail herein. Hydraulic accumulator 10, which in the present case is a pressure accumulator 10, is connected to remaining hydraulic system 16 via a hydraulic connection 18 with the aid of a device 20 which is explained in greater detail below. Device 20 includes a valve device 26 which is electromagnetically actuatable by a first control and/or regulating device 21 of the motor vehicle with the aid of an output stage 22. This is indicated symbolically by an arrow 24. Device 20 has a system-side port A and an accumulator-side port B for exchanging fluid. Control and/or regulating device 21 may be, for example, an engine control unit, a transmission control unit or another control unit of the motor vehicle.

Furthermore, a hydraulic pump 28, a hydraulic filter 30 and a controller 32 for regulating the system pressure are situated in hydraulic system 12, which is stated here by way of example. Hydraulic pump 28 is fed from a reservoir 34, which is connected to an output of controller 32. A port 36 connects the described assembly to automatic transmission 14, which is substitutionally represented in the drawing in FIG. 1 by a hydraulic control system 38 and valves 40, clutches 42 and brakes 44 included therein.

It is apparent that hydraulic system 12 is a closed system. Accordingly, it may be necessary to keep a volume and a pressure of the fluid located therein within certain limits. In the automatic transmission of a motor vehicle provided herein by way of example, which may be operated in a start-stop mode, the volume and the pressure of the fluid may, in particular, vary particularly greatly and rapidly. Pressure accumulator 10 is used primarily to store and provide hydraulic pressure and a certain amount of fluid if hydraulic pump 28 was turned off.

Device 20 and hydraulic accumulator 10 are designed to permit an exchange of fluid between hydraulic accumulator 10 and remaining hydraulic system 16, depending on an operating mode of the motor vehicle. During normal operation of the motor vehicle, hydraulic pump 28 is in operation and enables hydraulic accumulator 10 to be filled with fluid. In a stopping mode of the motor vehicle, however, hydraulic pump 28 is not in operation. Therefore, pressure losses may occur in hydraulic system 12—for example, as a result of leaks.

Shortly before and/or during a starting phase of the internal combustion engine of the motor vehicle, which follows the stopping mode, fluid may be introduced from hydraulic accumulator 10 into remaining hydraulic system 16 with the aid of device 20. This may take place comparatively quickly and using a small amount of energy. If a necessary operating pressure is subsequently reached in hydraulic system 12, due to the action of hydraulic pump 28, hydraulic accumulator 10 may conversely be refilled from remaining hydraulic system 16. This may take place comparatively slowly. Hydraulic accumulator 10 in FIG. 1 may be designed as a spring piston accumulator, a gas piston accumulator or a gas diaphragm accumulator having a barrier layer.

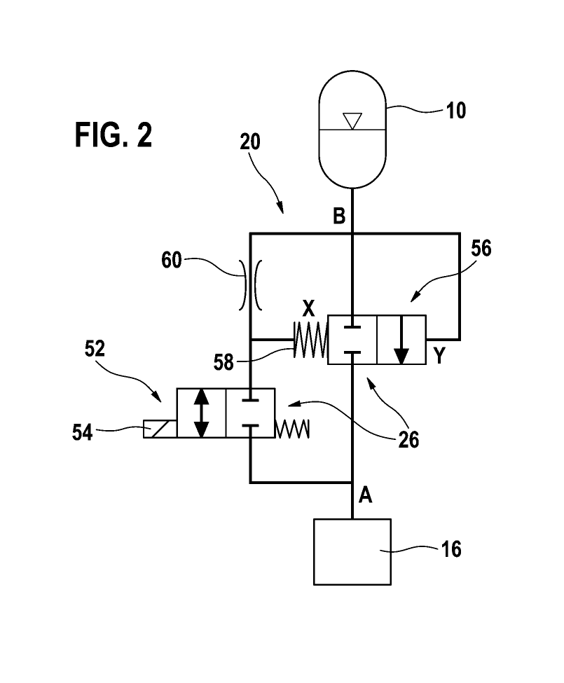

FIG. 2 shows device 20 for controlling hydraulic accumulator 10 of hydraulic system 12 in a first fundamental exemplary embodiment. In the present case, device 20 includes a 2/2-way control valve 52 (“pilot control valve”), which is actuatable with the aid of an electromagnet 54, as well as a valve main stage 56, which has a first hydraulic control port X which is hydraulically connected to a port of control valve 52. Control valve 52 and valve main stage 56 together form valve device 26. Accumulator-side port B of device 20 is connected to hydraulic accumulator 10, on the one hand, and to a first control port X, on the other hand, which acts in the closing direction of valve main stage 56, and to a second hydraulic control port Y of valve main stage 56, which acts in the opening direction, and system-side port A of device 20 is hydraulically connected to remaining hydraulic system 16, on the one hand, and to control valve 52 and valve main stage 56, on the other hand. A first throttle 60 is furthermore situated between control valve 52 and control port X of valve main stage 56 and accumulator-side port B.

In a first operating state of device 20, a hydraulic pressure at system-side port A is higher than a hydraulic pressure at accumulator-side port B. Electromagnet 54 is not energized; control valve 52 is therefore closed. The same relatively low pressure prevails at control ports X and Y. This may correspond, for example, to a normal, initial vehicle operation of the motor vehicle, as long as hydraulic accumulator 10 is not or is only partially filled with fluid. Valve main stage 56 is blocked by the action of a valve spring 58.

If electromagnet 54 is now energized, control valve 52 may open so that fluid may flow from system-side port A to accumulator-side port B via opened control valve 52 and first throttle 60. As a result, hydraulic accumulator 10 continues to be filled until the pressure at system-side port A is approximately the same as the pressure at accumulator-side port B, or until electromagnet 54 is switched off and control valve 52 is thus closed. The filling is therefore controlled by control valve 52, valve main stage 56 continuing to remain blocked.

In a second operating state of device 20, the hydraulic pressure at system-side port A may be higher than, equal to or less than the hydraulic pressure at accumulator-side port B. This may correspond, for example, to a normal vehicle operation or a stopping phase of the motor vehicle. Electromagnet 54 is not energized; control valve 52 is therefore closed. The pressure at accumulator-side port B is applied in the opening direction to valve main stage 56 at second control port Y, and the same pressure is applied in the closing direction to the valve main stage at control port X via first throttle 60. The force of valve spring 58 additionally acts upon valve main stage 56 in the closing direction, which therefore continues to remain blocked. The amount of fluid stored in hydraulic accumulator 10 is thus kept ready for a possible subsequent emptying operation.

In a third operating mode of device 20, hydraulic accumulator 10 is at least partially filled, and the hydraulic pressure at accumulator-side port B is higher than the hydraulic pressure at system-side port A. This may correspond to, for example, the stopping phase of the motor vehicle, in which hydraulic pump 28 does not operate, and the pressure in remaining hydraulic system 16 may be comparatively low as a result of leaks.

If a starting phase of the internal combustion engine takes place in this state, electromagnet 54 is energized shortly before and/or during the startup, so that control valve 52 opens. By connecting system-side port A to first control port X, the pressure at the latter drops so that valve main stage 56 is opened by the higher pressure prevailing at second control port Y (which corresponds to the pressure prevailing at accumulator-side port B).

The opening cross section of control valve 52 is dimensioned to be larger than the through-flow cross section of first throttle 60, so that more fluid may flow out than flow in, with regard to control port X, and the pressure at first control port X thus remains low. Valve main stage 56 opens thereby, so that fluid may flow from accumulator-side port B to system-side port A via valve main stage 56.

Hydraulic accumulator 10 is subsequently at least partially emptied comparatively quickly, after which the pressure in remaining hydraulic system 16 rises accordingly. This achieves the fact that the necessary hydraulic pressure for operating remaining hydraulic system 16 is present after starting the internal combustion engine. The emptying of hydraulic accumulator 10 ends when a pressure compensation has taken place between accumulator-side port B and system-side port A, or when electromagnet 54 is switched off.

This operation may be expressed by the following equation:

F_{F}+F_{X}+F_{A}+F_{B}<0; where

F_{F}=force of valve spring 58;
F_{A}=p_{A}·A_{A}=hydraulic pressure on valve main stage 56 at system-side port A;
F_{B}=P_{B}·A_{B}=hydraulic pressure on valve main stage 56 at accumulator-side port B or at second control port Y of valve main stage 56;
F_{X}=P_{X}·A_{X}=hydraulic pressure on valve main stage 56 at first control port X of valve main stage 56;
where “p” is the particular hydraulic pressures and “A” is the particular hydraulically active surfaces. The signs of the variables are selected in such a way that valve main stage 56 opens when the total shown in the formula is less than zero.

It is understood that the application in a motor vehicle described in FIG. 2 is only an example, and device 20 may also be used in other—stationary or mobile—hydraulic systems 12 in which an exchange of fluid in a hydraulic accumulator 10 is to be controlled.

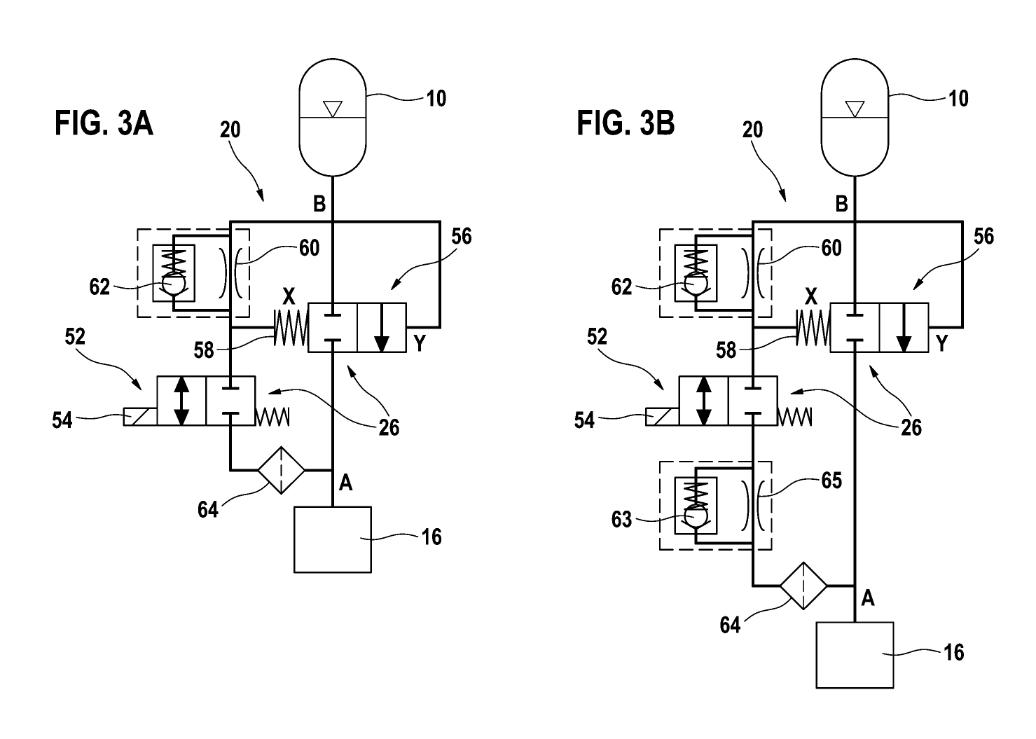

Based on the illustration in FIG. 2, FIG. 3A shows another exemplary embodiment of device 20, in which a check valve 62 is situated in parallel to first throttle 60, check valve 62 blocking in the direction of control valve 52. A filter 64 is additionally situated in the hydraulic connection between system-side port A and control valve 52.

It is apparent that check valve 62 may open in the first operating state during filling of hydraulic accumulator 10, so that, in addition to first throttle 60, fluid flows into hydraulic accumulator 10 under a low flow resistance. This makes it possible to design first throttle 60 to have a smaller through-flow cross section, compared to device 20 according to FIG. 2. The filling may take place comparatively rapidly, thanks to check valve 62, and it may be essentially delimited by the opening cross section of control valve 52—depending on the hydraulic pressure difference.

If hydraulic accumulator 10 is at least partially emptied in the third operating state, for the purpose of additionally filling remaining hydraulic system 16 with fluid, this results in a similar behavior of device 20, as described above. Check valve 62 is blocked. For device 20 in FIG. 3A, it is likewise necessary to dimension the opening cross section of control valve 52 to be larger than the through-flow cross section of first throttle 60, so that more fluid may flow out than flow in with regard to control port X. As a result, the pressure in the control area remains so low that valve main stage 56 may open. Throttle 60 may have a comparatively small design.

Additional advantageous characteristics or structural degrees of freedom in relation to FIG. 2 thus result for device 20 in FIG. 3A. On the one hand, the filling of hydraulic accumulator 10 may take place faster during opening of check valve 62. On the other hand, the fluid pressure at control port X or in the control area of valve main stage 56 may be comparatively low in the third operating state during emptying of hydraulic accumulator 10, due to the smaller through-flow cross section of first throttle 60. A desired valve lift and/or a switching behavior of valve main stage 56 may thereby be increased or improved. Likewise, control valve 52 may have a smaller dimension, and the dimensioning of valve main stage 56 may be implemented according to manufacturing requirements.

In addition, check valve 62 and throttle 60 may be designed as a common element, for example with the aid of an axial bore or groove in a valve body or in a valve seat of check valve 62.

FIG. 3B shows one exemplary embodiment of device 20 which is based on FIG. 3A. In addition to FIG. 3A, device 20 of FIG. 3B has an additional check valve 63 and a throttle 65 which is parallel-connected to additional check valve 63 in the hydraulic connection between control valve 52 and filter 64. Check valve 63 may be blocking in the direction of system-side port A. This results in additional options for influencing or setting the volumetric flows or pressure differences which result between system-side port A and control port X of valve main stage 56 in a particular operating state.

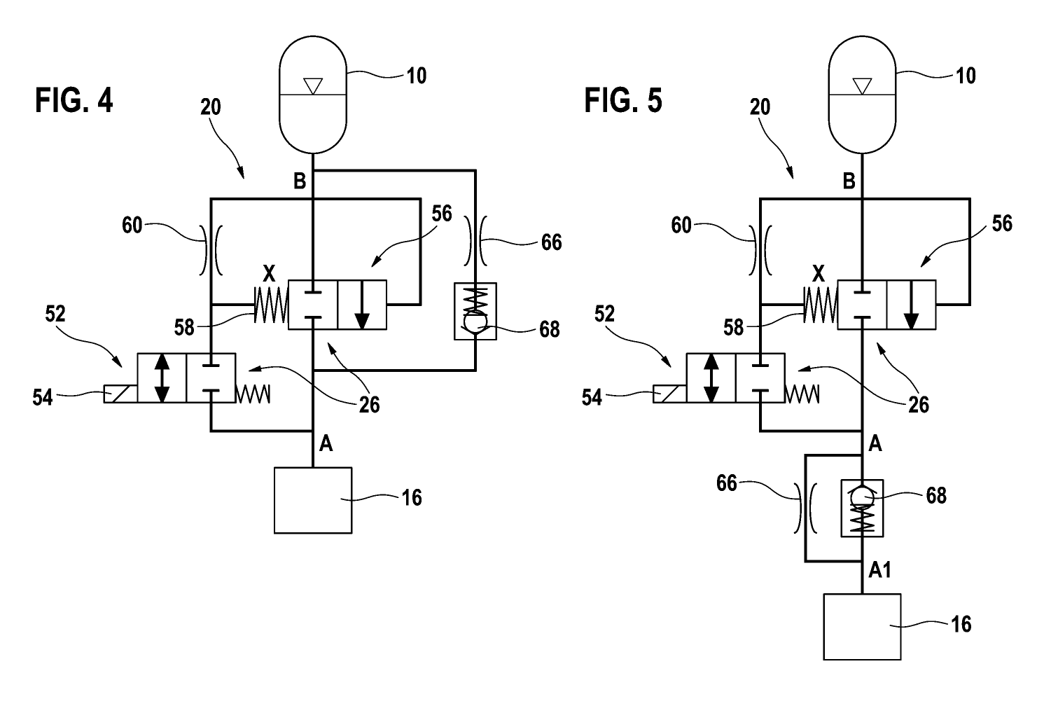

FIG. 4 shows another exemplary embodiment of device 20, which is again based on the illustration in FIG. 2, in which a hydraulic connection which is parallel to valve main stage 56 is situated between system-side port A and accumulator-side port B, the hydraulic connection including a second throttle 66 and a check valve 68, which is situated in series thereto and which is blocking in the direction of system-side port A.

It is apparent that check valve 68 may open when the hydraulic pressure at system-side port A is higher than the hydraulic pressure at accumulator-side port B. In this way, hydraulic accumulator 10 may be continuously filled via second throttle 66 independently of the position of control valve 54—if there is a corresponding pressure difference—the force of the fluid flow through the through-flow cross section of second throttle 66 being delimited. It is not necessary to actuate control valve 52 for this purpose.

In the third operating state of device 20, check valve 68 is blocked, and the emptying of hydraulic accumulator 10 takes place as described in FIG. 2 above.

FIG. 5 shows another exemplary embodiment of device 20, again based on the illustration in FIG. 2, in which a parallel connection of second throttle 66 and check valve 68 are situated in series to system-side port A, check valve 68 blocking in the direction of accumulator-side port B.

For the sake of a uniform representation, system-side port A continues to be defined at the hydraulic connection of control valve 52 and valve main stage 56 in FIG. 5, and an interface A1 is additionally defined below second throttle 66 and check valve 68 in the direction of remaining hydraulic system 16 in the drawing in FIG. 5. In the present case, device 20 therefore also includes interface A1.

In the first operating state of device 20, the filling of hydraulic accumulator 10 takes place similarly to the illustration in FIG. 2, with the difference that the fluid flow is additionally throttled via second throttle 66. In the third operating state of device 20, the emptying of hydraulic accumulator 10 is again similar to FIG. 2, check valve 68 opening, and the fluid flow being able to flow unhindered to system-side port A.

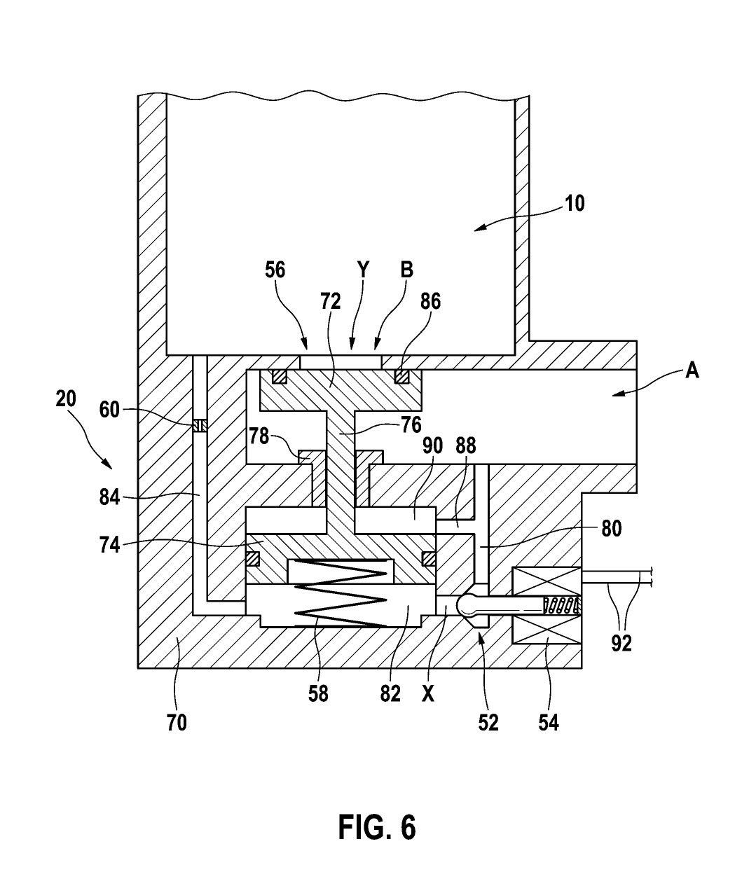

FIG. 6 shows one exemplary embodiment of device 20, together with hydraulic accumulator 10, in a simplified sectional representation. Hydraulic accumulator 10, which may exchange fluid with remaining hydraulic system 16 via system-side port A in the right area of the drawing, is partially illustrated in the upper area of the drawing. Hydraulic accumulator 10 is closed on all sides and has only accumulator-side port B.

A housing 70, which includes essential elements of device 20, is illustrated in the lower area of the drawing. In FIG. 6, a valve body 72, which is rigidly coupled with a piston 74 via a piston rod 76, is vertically movable in a fluid-tight guide 78. Control valve 52, which is actuatable by electromagnet 54 and which may block or open a hydraulic connection 80 between system-side port A and a control area 82 of valve main stage 56 belonging to control port X, is situated at the lower right of the drawing. In the de-energized state, control valve 52 is blocked by the force of a helical spring (without a reference numeral). First throttle 60 is situated in another hydraulic connection 84 between hydraulic accumulator 10 and control area 82 in a left area of the drawing in FIG. 6.

In the drawing, valve body 72 has an upper end position in which it closes an opening of hydraulic accumulator 10 which forms accumulator-side port B, with the aid of an annular sealing element 86. Valve spring 58 is situated between piston 74 and a lower section of housing 70 in the drawing in such a way that it acts on piston 74 upwardly in the drawing in the closing direction of valve main stage 56. A fluid channel 88 connects an upper pressure chamber 90 of piston 74 in the drawing to system-side port A and permits a corresponding pressure compensation.

In the first operating state of device 20, a hydraulic pressure at system-side port A is higher than a hydraulic pressure at accumulator-side port B. When electromagnet 54 is energized with the aid of two connecting lines 92, control valve 52 then opens hydraulic connection 80 so that fluid may flow from system-side port A to control port X or control area 82, and from there into hydraulic accumulator 10 via further hydraulic connection 84 and first throttle 60. Hydraulic accumulator 10 is filled thereby as long as electromagnet 54 is being energized. At the end of the current feed, control valve 52 is blocking, after which the pressure in control area 82 may assume approximately the same pressure as the fluid present in hydraulic accumulator 10.

In the second operating state of device 20, the fluid stored in hydraulic accumulator 10 is kept ready for a possible subsequent emptying, electromagnet 54 no longer being energized.

In the third operating mode of device 20, hydraulic accumulator 10 is at least partially filled, and the hydraulic pressure at accumulator-side port B is higher than the hydraulic pressure at system-side port A. When electromagnet 54 is energized, fluid may flow from control area 82 to system-side port A via hydraulic connection 80. The pressure in control area 82 subsequently drops, so that the upward-acting hydraulic force in the drawing is smaller in control area 82 than the downward-acting force in the drawing on valve body 72 at accumulator-side port B. Valve main stage 56 subsequently opens, after which fluid may flow from hydraulic accumulator 10 to system-side port A, so that the hydraulic pressure in remaining hydraulic system 16 may rise.

It is conceivable to add a second throttle 66 and a check valve 68 to device 20 in FIG. 6, for example according to the schematic representation in FIG. 4, and thus permit continuous “passive” filling of hydraulic accumulator 10—under corresponding pressure conditions. However, this is not illustrated in FIG. 6.

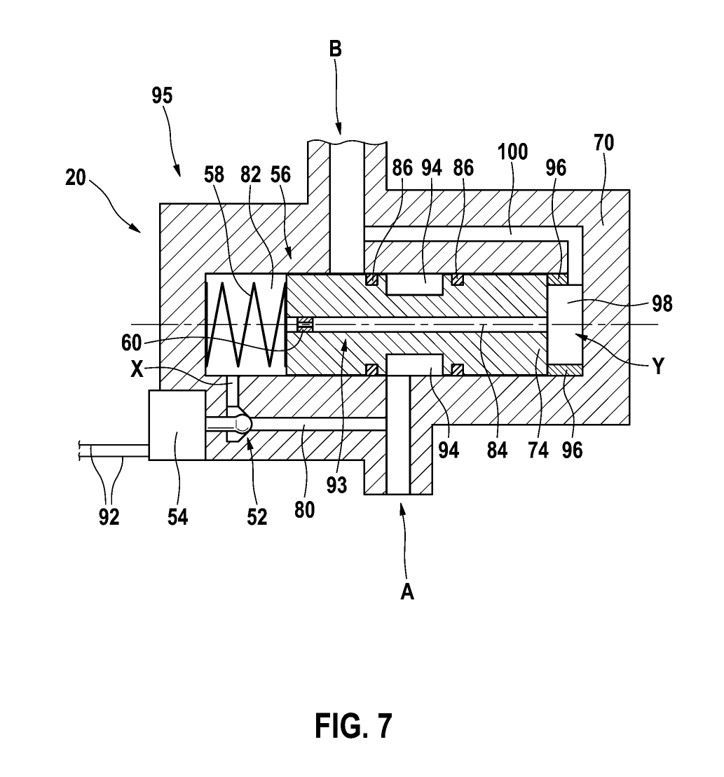

FIG. 7 shows another exemplary embodiment of device 20 as a “pilot-controlled” slide valve 95. In contrast to FIG. 6, piston 74 is designed as a so-called “slide piston,” hydraulic connection 84 being designed as an axial channel 93 of piston 74, in which throttle 60 is also situated.

Piston 74 is horizontally movable in the drawing in FIG. 7 and has an annular groove 94, with the aid of which valve main stage 56 may establish a hydraulic connection between system-side port A and accumulator-side port B. Annular groove 94 is sealed on both sides with the aid of annular sealing elements 86, which are situated in annular grooves (no reference numerals) in the outer lateral surface of piston 74. In the drawing, piston 74 has struck an annular stop 96 on the face—supported by valve spring 58. Stop 96 surrounds a fluid chamber 98, which forms second control port Y and which is connected to accumulator-side port B via a hydraulic connection 100.

In the second operating state of device 20, in which the hydraulic pressure at system-side port A is higher than the hydraulic pressure at accumulator-side port B, piston 74 has struck stop 96 and valve main stage 56 is blocking. Control valve 52 is blocked by the force of a helical spring (not illustrated).

When electromagnet 54 is energized in the first operating state, control valve 52 opens so that fluid may flow from system-side port A to accumulator-side port B via hydraulic connection 80, control area 82, throttle 60, hydraulic connection 84, fluid chamber 98 and hydraulic connection 100, similarly to FIG. 6, thereby filling the accumulator.

In the third operating state of device 20, electromagnet 54 is again energized. The pressure in control area 82 may subsequently drop, so that piston 74 may be displaced to the left in the drawing against the force of valve spring 58, due to the higher pressure at accumulator-side port B (or second control port Y) in relation to system-side port A (or first control port X). A hydraulic connection is thus established between accumulator-side port B and system-side port A with the aid of annular groove 94. Valve main stage 56 is thus opened with a comparatively large cross section until a pressure compensation takes place between hydraulic accumulator 10 (not illustrated) and remaining hydraulic system 16 (also not illustrated), or until electromagnet 54 is switched off.

As in FIG. 6, it is conceivable to add a second throttle 66 and a check valve 68 to device 20, and thus permit continuous “passive” filling of hydraulic accumulator 10—under corresponding pressure conditions. However, this is not illustrated in FIG. 7.

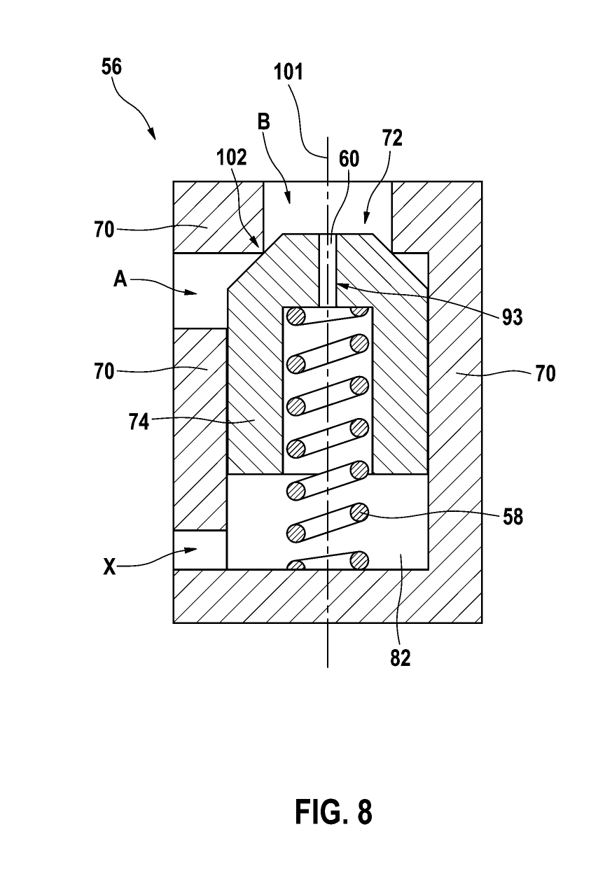

FIG. 8 shows another exemplary embodiment of valve main stage 56 in a greatly simplified sectional representation. In the present case, valve main stage 56 is designed to be essentially rotationally symmetrical to a longitudinal axis 101. Multiple sections of housing 70 are illustrated, which surround piston 74, valve spring 58 and control area 82, among other things.

In the drawing in FIG. 8, piston 74 is vertically movable. In FIG. 8, an upper end section of piston 74 forms valve body 72, which has a conical design in FIG. 8. In the present case, piston 74 is in a topmost position in the drawing, so that valve body 72 is pressed against a valve seat 102. As a result, system-side port A is hydraulically separated from accumulator-side port B, and valve main stage 56 is thus blocked.

Control area 82, which may exchange fluid via control port X, is located in a lower area in the drawing. At a higher pressure at accumulator-side port B in relation to system-side port A, valve main stage 56 initially remains blocked, since a pressure compensation may take place on both sides of piston 74 with the aid of throttle 60, which in the present case is designed as axial channel 93 in piston 74, as long as no fluid is exchanged via control port X and piston 74 is pressed upward in the direction of the closing position by the force of valve spring 58.

The functionality of valve main stage 56, together with control valve 52—which is not illustrated in the drawing in FIG. 8—essentially corresponds to FIGS. 6 and 7, as already described above.

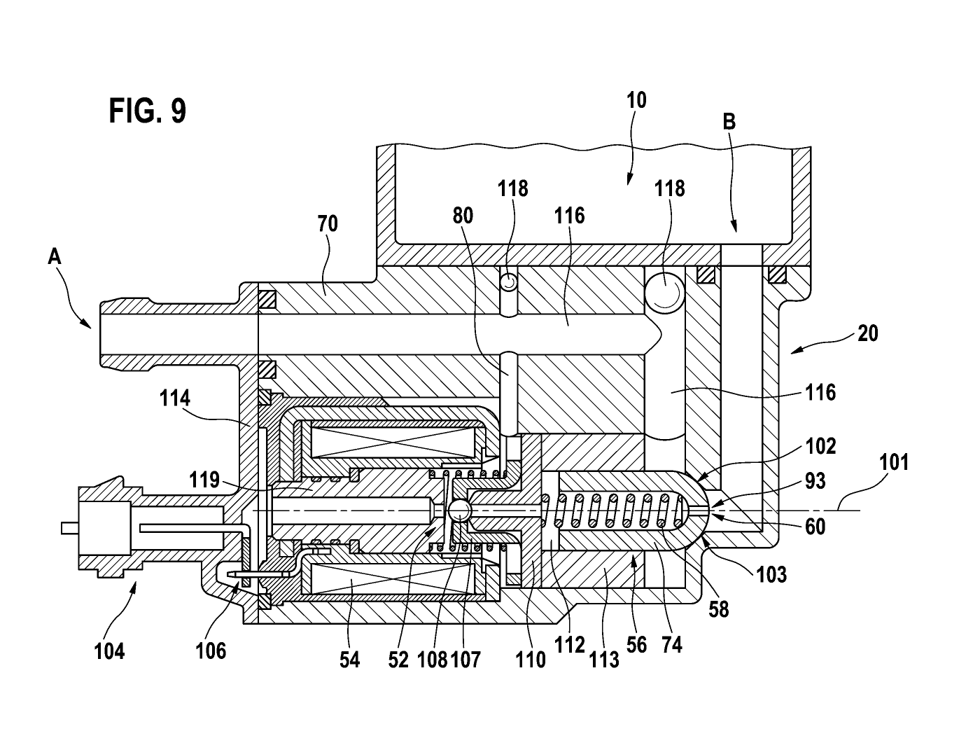

FIG. 9 shows a sectional view of a device 20 which is electrically actuatable by control and/or regulating device 21 of the motor vehicle and which controls the access to hydraulic accumulator 10. The upper part of hydraulic accumulator 10, which is not illustrated in the drawing, is sealed pressure-tight. The hydraulic arrangement of the elements situated therein as well as the functionality essentially correspond to device 20 illustrated in FIG. 2.

Device 20 includes housing 70, in which a number of elements are situated. In a lower area in the drawing and viewed from left to right, device 20 includes the following elements, among other things: a plug connector 104, an electrical contact 106 and electromagnet 54, which may actuate control valve 52. Control valve 52 includes a valve ball 108, which is situated in an armature 107, and a washer 110. Valve main stage 56 is situated in the lower right area of the drawing. Piston 74 is situated in a fluid chamber 112 in such a way that it is movable in the direction of longitudinal axis 101 with the aid of a friction bearing 113.

System-side port A, which is structurally integrated along with plug connector 104 into a cover 114, is situated on the left in the middle area of the drawing in FIG. 9. A channel 116 connects system-side port A to valve main stage 56, among other things. Hydraulic connection 80 connects channel 116 to control valve 52. For this purpose, two bores are provided in housing 70 which are carried out transversely in relation to longitudinal axis 101 and which are calked fluid-tight with the aid of spherical seals 118 on outer sections of housing 70.

Similarly to FIG. 8, first throttle 60 in FIG. 9 is designed as axial channel 93 with the aid of a longitudinal bore in piston 74. Valve spring 58 is situated in a cylindrical cavity of piston 74 and presses piston 74 to the right in the drawing against conically designed valve seat 102. An associated sealing section 103 on piston 74 has an approximately semispherical geometry.

Likewise, a valve spring (no reference number) of control valve 52 presses armature 107, together with valve ball 108, in the direction of washer 110 without current feed to electromagnet 54, so that control valve 52 may close. When electromagnet 54 is energized, armature 107 is pulled in by a magnet core 119, so that valve ball 108 is lifted from washer 110 and thus opens control valve 52.

Device 20 in FIG. 9 essentially has three main leak paths. The first is on the sealing seat of control valve 52, the second on valve seat 102 of valve main stage 56 and the third over the annular gap formed between piston 74 and friction bearing 113. The gap may also be designed as a gap seal, a radial clearance of, for example, +/−20 μm being suitable. Piston 74 and friction bearing 113 preferably have similar thermal coefficients of expansion and may be made of steel or sintered bronze. In addition, piston 74 has a shoulder in the cylindrical cavity for accommodating spring 58, the shoulder being used to guide spring 58 and simultaneously protect it against overloads.

Device 20 illustrated in FIG. 9 may support the aforementioned start-stop function of the internal combustion engine of the motor vehicle in that a fluid exchange between hydraulic system 12 of automatic transmission 14 and hydraulic accumulator 10 may be carried out in a controlled manner.

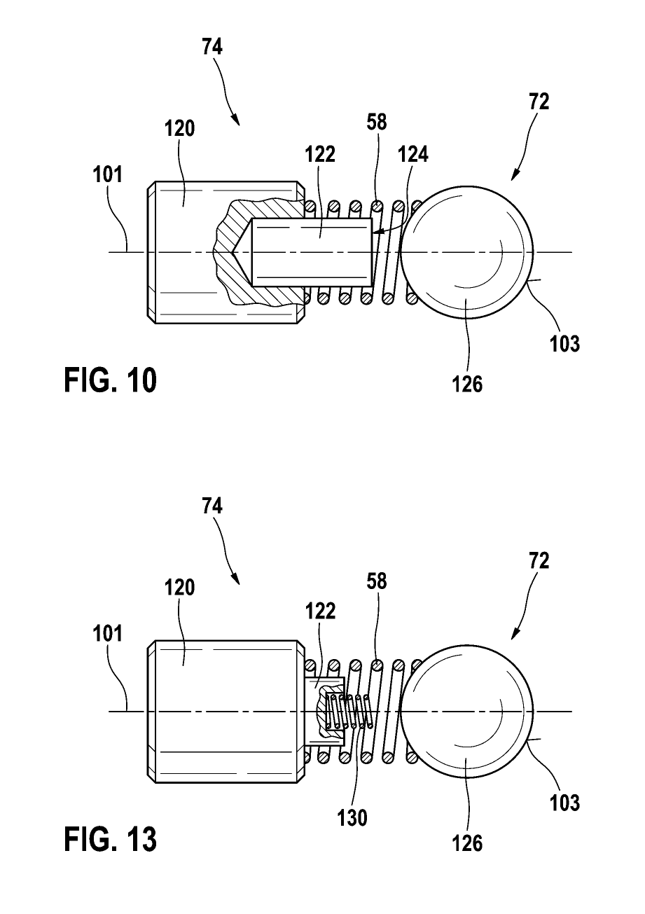

FIG. 10 shows a partial sectional view of a schematic exemplary embodiment of piston 74 of valve main stage 56. The elements illustrated are designed to be essentially rotationally symmetrical to longitudinal axis 101. In the present case, piston 74 includes a guiding section 120, which may slide in friction bearing 113. A stop element 122, which has a stop surface 124 against which a valve ball 126 may strike, is situated in guiding section 120. Valve spring 58 is situated radially around stop element 122.

It is apparent that, in contrast to piston 74 in FIG. 9, the “guiding” and “sealing” functions are distributed to separate elements, namely guiding section 120 and valve ball 126. This makes it possible to balance tolerances and improve the function of valve main stage 56. Stop element 122 may reduce the operating noise of valve main stage 56 and, if suitably dimensioned, delimit the opening cross section of valve main stage 56. In contrast to piston 74 in FIG. 9, however, the configuration according to FIG. 10 has no longitudinal bore and thus no integrated first throttle 60.

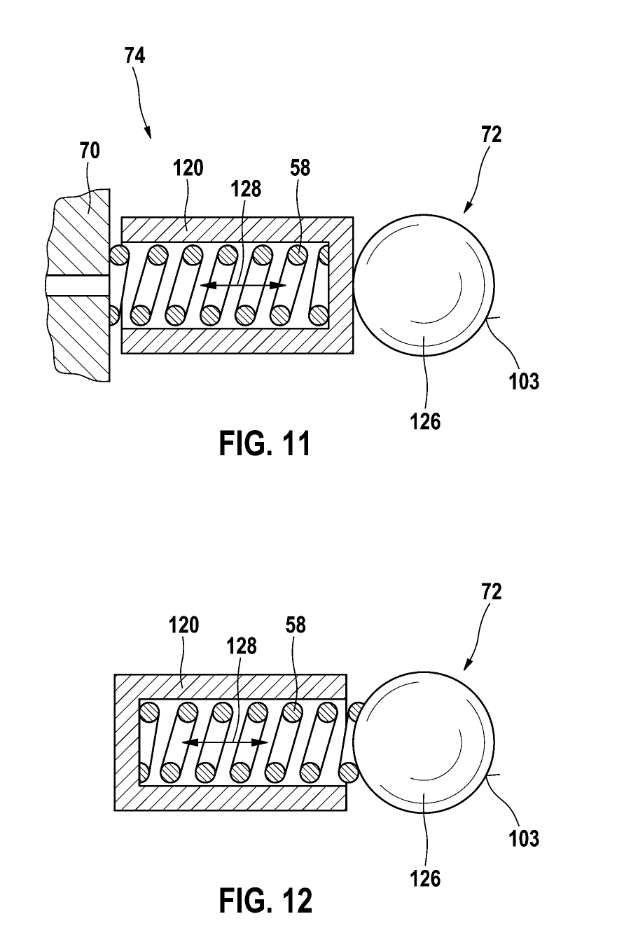

FIG. 11 shows another exemplary embodiment of piston 74 in a sectional view. In the present case, guiding section 120, which may slide in friction bearing 113 in the direction of an arrow 128, is designed as cylindrical sleeve 120. On the left in the drawing, sleeve 120 has an opening through which valve spring 58 may emerge and be supported, for example, on a section of housing 70 or washer 110. Friction bearing 113 and other elements or housing sections situated in the surroundings of piston 74 are not illustrated in FIG. 11.

It is apparent that sleeve 120 strikes valve ball 126 only in the direction of arrow 128, so that valve ball 126 may have a clearance perpendicular to arrow 128. This makes it possible to improve the seating of valve ball 126 on valve seat 102—which is not shown in FIG. 11.

FIG. 12 shows another exemplary embodiment of piston 74 in a sectional view. Guiding section 120 is again designed as a cylindrical sleeve 120, which, in the drawing, opens to the right in the direction of valve ball 126. Valve spring 58 is supported on an inner area of sleeve 120 and may press directly onto valve ball 126. The remaining properties of piston 74 are comparable to FIG. 11.

FIG. 13 shows another exemplary embodiment of piston 74, based on FIG. 10. In addition to FIG. 10, a damping spring 130 is situated in the direction of valve ball 126 in a recess on the face of stop element 122. This makes it possible to further improve the function of piston 74 or valve main stage 56.

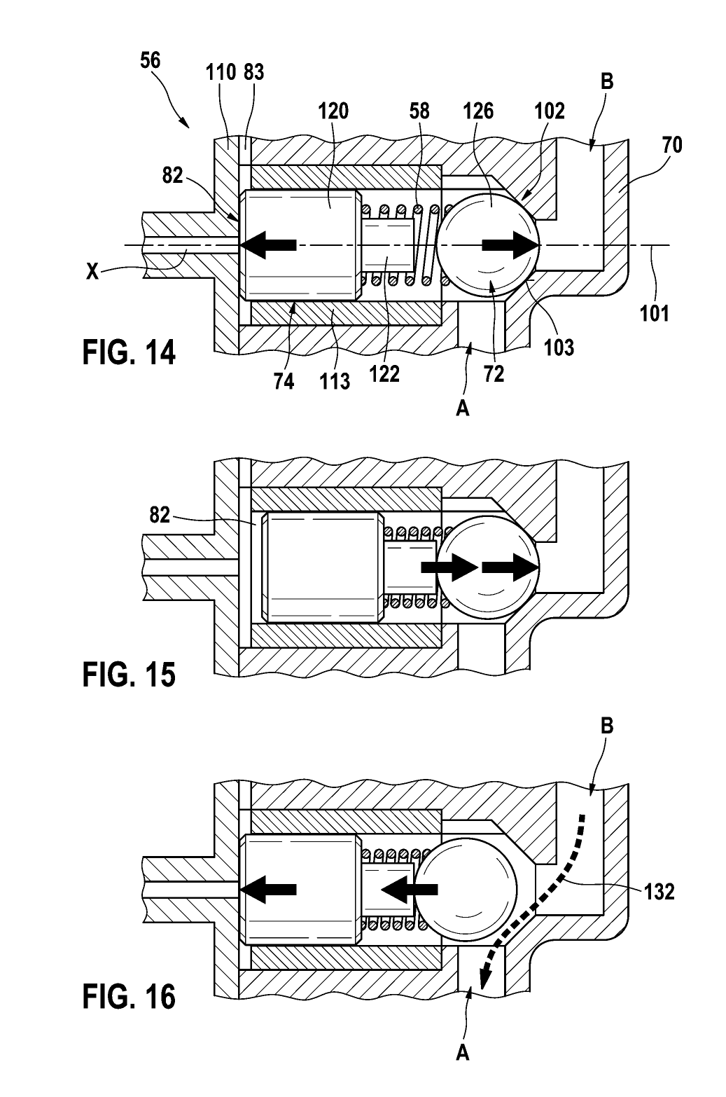

FIG. 14 shows piston 74 of valve main stage 56 in the exemplary embodiment according to FIG. 10, together with elements surrounding piston 74, in a partially sectional representation.

Because piston 74 or valve ball 126 does not have a bore in the direction of longitudinal axis 101, the configuration according to FIG. 14 has a hydraulic connection 83 in the upper left area of the drawing, which has a check valve 134—not illustrated in FIG. 14—through which a fluid exchange to accumulator-side port B may take place.

FIG. 14 shows a basic state in which piston 74 is pressed to the left in the drawing against washer 110, and valve ball 126 is pressed to the right onto valve seat 102. This is indicated by arrows in the drawing. With the aid of valve springs 58, it is achieved that the elements of valve main stage 56 may assume a defined position in each operating state.

FIG. 15 shows valve main stage 56 of FIG. 14 during filling of hydraulic accumulator 10—which is not illustrated in the drawing—and during subsequent holding of the fluid pressure which has built up in hydraulic accumulator 10. The elements of valve main stage 56 correspond to those of FIG. 14, so that, for the sake of simplicity, their reference numerals are not repeated in this case.

During filling, control valve 52 (not illustrated) is open so that fluid may flow into control area 82 of piston 74 or of guiding section 120 via control port X. Piston 74 presses onto valve ball 126 with the aid of stop element 122 and supports the sealing action on valve seat 102.

While holding the fluid pressure in hydraulic accumulator 10, control valve 52 (not illustrated) is closed. The elements remain in the position shown in FIG. 15.

FIG. 16 shows valve main stage 56 of FIG. 14 during emptying of hydraulic accumulator 10 for the purpose of discharging fluid into remaining hydraulic system 16. Control valve 52 (not illustrated) is open so that, as a result of the hydraulic pressure acting upon valve ball 126 from accumulator-side port B, valve ball 126 and likewise piston 74 are pressed to the left in the drawing, so that valve main stage 56 opens and fluid may flow from accumulator-side port B to system-side port A in the direction of a line 132.

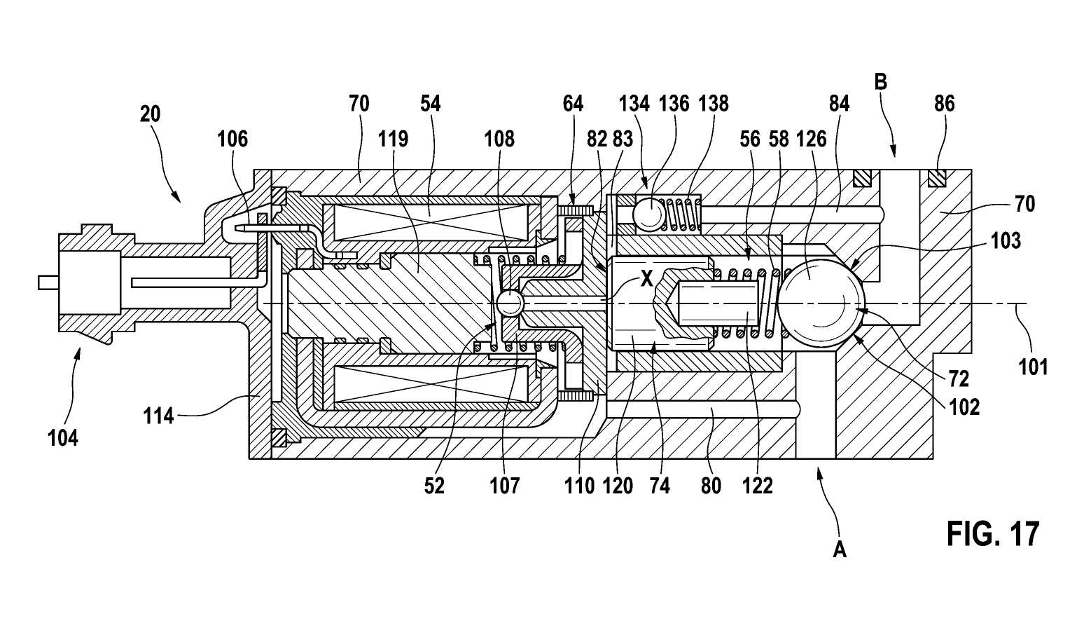

FIG. 17 shows another exemplary embodiment of device 20—based on the representations in FIGS. 14 through 16—in a sectional view. The elements illustrated in the left area of the drawing, in particular plug connector 104, electrical contacting 106, electromagnet 54 and control valve 52, essentially correspond to device 20 in FIG. 9. Reference is thus made to the description for FIG. 9.

Piston 74 or guiding section 120, stop element 122, valve spring 58 and valve ball 126 correspond to the configuration according to FIG. 10. In FIG. 17, control area 82 of valve main stage 56 is connected to accumulator-side port B via hydraulic connection 83 and via a check valve 134 situated therein which is blocking in the direction of control area 82. Check valve 134 includes a valve ball 136 and a valve spring 138. The port of control valve 52 facing away from control port X is connected to system-side port A via a hydraulic connection 80 and an annular filter 64 for filtering the fluid.

The function of valve main stage 56, in particular in relation to guiding section 120 and valve ball 126, corresponds to the representations in FIGS. 14 through 16. Valve ball 126 is a standard component and, in the present case, is guided by webs in housing 70 which run in the direction of longitudinal axis 101. The webs are only indicated in the drawing.

A number of possible exemplary structural embodiments and/or alternatives of device 20 are explained in greater detail below. For example, housing 70 may be injection-molded from plastic, for example from plastic of the type PA66GF30. Friction bearing 113 is made, for example, of a “BP25” or “PTFE” material in an injection molding process and may be pressed into a section of housing 70. Valve ball 126 may be guided along injection-molded guides in housing 70. Guiding section 120 may be made, for example, of steel and ground on the surfaces subjected to sliding friction, for example with the aid of a so-called “centerless” method. A fitting accuracy of, for example, +/−20 μm may thus be achieved.

Check valve 62 together with integrated first throttle 60 may furthermore be pressed into hydraulic connection 84 of FIG. 17, for example in device 20 according to the exemplary embodiment of FIG. 3A. A washer of check valve 62, which causes the blocking of check valve 62 instead of a valve ball 136, may be manufactured as a stamped/punched part.

Washer 110 may furthermore be made of plastic in an injection molding process, it being possible to press annular filter 64 onto or into washer 110, if necessary. Additionally or alternatively, a sealing welding may also be carried out with the aid of an ultrasonic method, a friction method or a laser welding method. Control valve 52 may be pressed into a section of housing 70 and/or a section of electromagnet 54.

Cover 114 may furthermore be made of the same material as housing 70 and be attached thereto by pressing on or latching. Additionally or alternatively, cover 114 may be attached to housing 70 with the aid of an ultrasonic method, a friction method or a laser welding method. This may be necessary, for example, if complete tightness is required.

A standardized interface which matches a present design of hydraulic accumulator 10 may also be used for accumulator-side port B. Hydraulic accumulator 10 may, for example, be pressed or latched onto device 20.

In addition, valve spring 58, first throttle 60, second throttle 66 and stop element 122 may be dimensioned as a function of requirements of hydraulic system 12 and/or automatic transmission 14. Moreover, the intensity and/or duration of activation 142 may be selected as a function of properties of control valve 52 and/or requirements for operating automatic transmission 14. The fluid flows, hydraulic pressures and/or filling volume of the hydraulic accumulator may also be flexibly taken into account by suitably dimensioning the elements of device 20, in particular in relation to a start-stop function of the internal combustion engine.

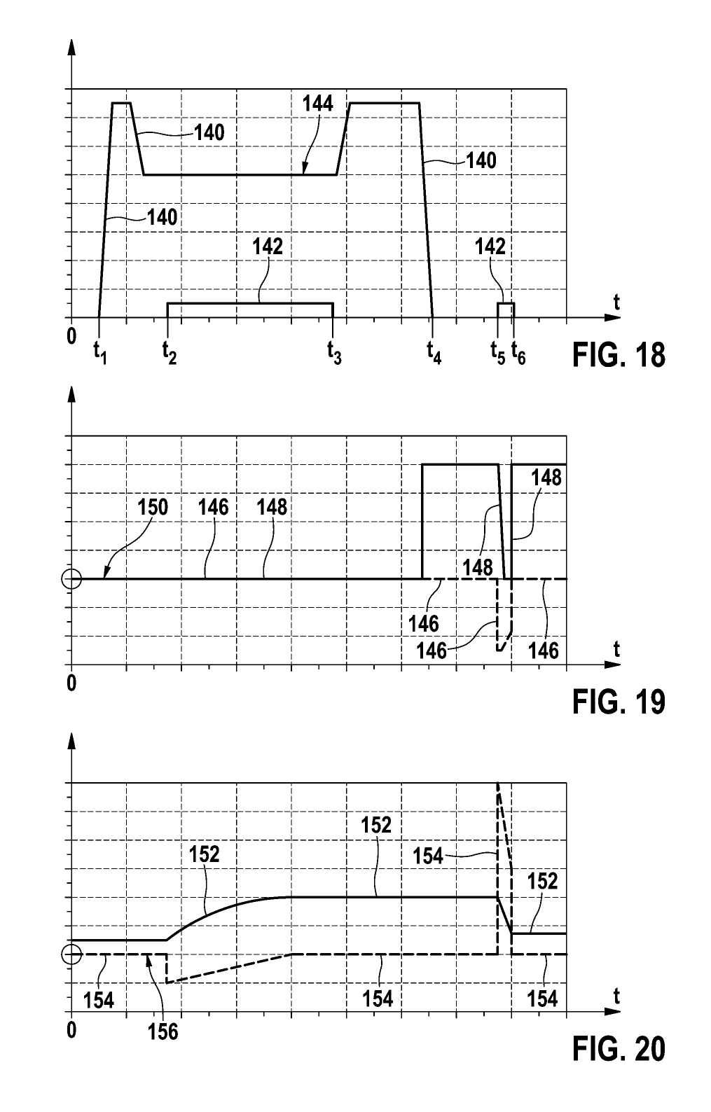

FIGS. 18 through 20 show three timing diagrams for explaining the function of device 20 according to FIG. 17, reference also being made to the elements shown therein. The timing diagrams are plotted on a time axis t and have the same time scale in relation to each other.

FIG. 18 shows a diagram which has a delivery pressure 140 of hydraulic pump 28 as well as an activation 142 of control valve 52.

At a point in time t1, hydraulic pump 28 begins to deliver, after which delivery pressure 140 increases and subsequently adjusts to an operating pressure 144. At a point in time t2, electromagnet 54 of control valve 52 is energized, so that fluid may flow from system-side port A into control area 82 of valve main stage 56 via opened control valve 52. Check valve 134 subsequently opens so that fluid may flow on to accumulator-side port B and thus fill hydraulic accumulator 10.

At a point in time t3, the current feed to electromagnet 54 is switched off. Control valve 52 is subsequently blocking. Hydraulic pump 28 is then switched off, for example in a stopping phase of the internal combustion engine. At a point in time t4, delivery pressure 140 is zero, and the hydraulic pressure in hydraulic system 12 is becoming lower—for example, due to leaks.

From a point in time t5 and until a point in time t6, activation 142 of control valve 52 takes place by energizing electromagnet 54 for a comparatively short period of time in which fluid may flow from hydraulic accumulator 10 back into remaining hydraulic system 16 at a comparatively high flow rate.

Simultaneously with FIG. 18, FIG. 19 shows a deflection 146 of valve ball 126 as well as a deflection 148 of piston 74 or guiding section 120 in the direction of longitudinal axis 101. A reference line 150 in relation to valve ball 126 means that the latter is seated on valve seat 102 and in relation to piston 74 that the latter is seated on the left stop on washer 110 in the drawing of FIG. 17.

Simultaneously with FIGS. 18 and 19, FIG. 20 shows an accumulator pressure 152 in hydraulic accumulator 10, which in the present case is designed as a piston spring accumulator, and a volumetric flow 154 characterizes the flow rate. The positive value range above a zero line 156 means, in relation to hydraulic accumulator 10, a stored fluid volume corresponding to accumulator pressure 152 and, in relation to volumetric flow 154, a flow of fluid out of hydraulic accumulator 10.

The functionality of device 20 in the three operating states of “filling”, “holding” and “emptying” is apparent by viewing FIGS. 18 through 20 together.

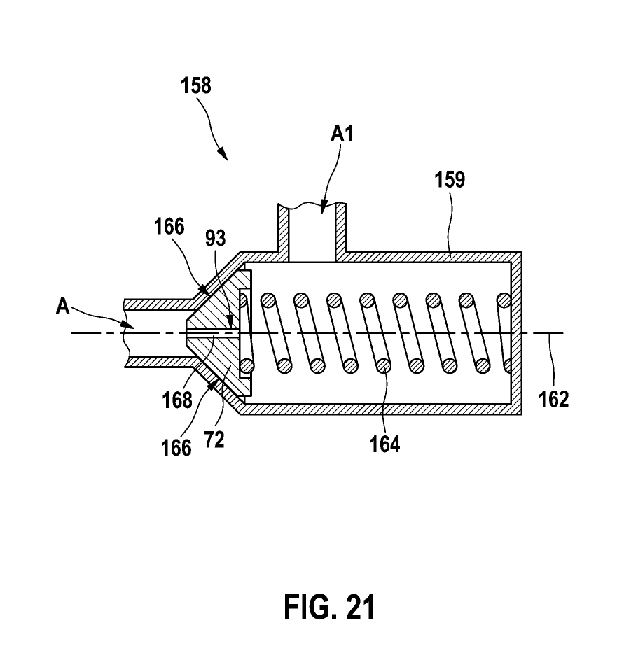

FIG. 21 shows one exemplary embodiment matching FIG. 5 of a combined configuration 158 of second throttle 66 and check valve 68. A valve housing 159 includes system-side port A as well as interface A1 in the direction of remaining hydraulic system 16.

Valve body 72 is situated in valve housing 159 in the form of a conical washer, which may be pressed in the direction of a longitudinal axis 162 onto a conical valve seat 166 with the aid of a valve spring 164. Valve body 72 has an axial diaphragm 168, through which fluid may flow when the valve is blocked. A through-flow cross section of diaphragm 168 delimits a possible fluid flow.

1-19. (canceled)

20. A device for controlling a hydraulic accumulator of a hydraulic system, comprising:
a valve device configured to connect and disconnect an accumulator-side port of the device to and from a system-side port;
wherein the valve device includes at least one valve main stage, which is situated hydraulically between the accumulator-side port and the system-side port and to which a pressure prevailing hydraulically at the accumulator-side port is preferably applied by an application element in an opening direction, and an electrically actuated control valve which connects the system-side port to a control port of the valve main stage which acts in a closing direction of the valve main stage and to the accumulator-side port, at least one first throttle being situated between the control valve and the accumulator-side port.

21. The device according to claim 20, wherein the valve main stage includes a spring which acts in the closing direction.

22. The device according to claim 20, wherein the device includes a check valve which is situated in parallel to the first throttle and is blocking in a direction of the control valve.

23. The device according to claim 20, wherein the device includes a second throttle and a check valve which are situated in series with each other and, as a whole, in parallel to the valve main stage, the check valve blocking in a direction of the system-side port.

24. The device according to claim 20, wherein the device includes a second throttle and a check valve which are situated in parallel to each other and, as a whole, between the control valve and the valve main stage, on one end, and the system-side port, on an other end.

25. The device according to claim 20, wherein a filter is situated between the control valve and the system-side port.

26. The device according to claim 20, wherein an opening cross section of the control valve is larger than a through-flow cross section of the first throttle.

27. The device according to claim 20, wherein the first throttle is a channel in a valve body of the valve main stage, the channel remaining open when the valve body is seated on a sealing seat.

28. The device according to claim 20, wherein the valve main stage has a valve body which has a conical sealing section or a spherical sealing section.

29. The device according to claim 28, wherein the valve body is configured to form a single piece with a guiding section which is used to guide the valve body in a valve housing.

30. The device according to claim 28, wherein the valve body and a guiding section, which is used to guide the valve body in a valve housing, are separate parts.

31. The device according to claim 30, wherein a spring is braced between the guiding section and the valve body.

32. The device according to claim 31, wherein a damping spring is situated between the guiding section and the valve body.

33. The device according to claim 20, wherein the valve main stage is configured as a slide valve.

34. The device according to claim 30, wherein a stop element is situated between the guiding section and the valve body.

35. The device according to claim 30, wherein an axially acting damping element is situated between the guiding section and the valve body, the axially acting damping element also delimiting an axial distance between the guiding section and the valve body.

36. The device according to claim 20, wherein an opening cross section of the control valve is smaller than an opening cross section of the valve main stage.

37. The device according to claim 29, wherein a material of a friction bearing, in which the guiding section is slidable, has approximately a same coefficient of thermal expansion as a material of the guiding section.

38. The device according to claim 30, wherein a material of a friction bearing, in which the guiding section is slidable, has approximately a same coefficient of thermal expansion as a material of the guiding section.
